(19) United States
(12) Patent Application Publication
(10) Pub. No.: US 2009/0075242 A1
(43) Pub. Date: Mar. 19, 2009

(54) SYSTEM AND METHOD FOR AUTOMATICALLY DEFINING, CREATING, AND MANAGING MEALS

(75) Inventors: Robert Schwarzberg, Boca Raton, FL (US); Marion Zabinski, San Diego, CA (US); Rene Melton, Delray Beach, FL (US); Timothy J. Dion, Parkland, FL (US)

Correspondence Address: STANDLEY LAW GROUP LLP, 6300 Riverside Drive, Dublin, OH, 43017, US

(73) Assignee: Sensei, Inc., Boca Raton, FL (US)

(21) Appl. No.: 12/119,932

(22) Filed: May 13, 2008

Related U.S. Application Data
(63) Continuation-in-part of application No. 12/117,190, filed on May 8, 2008.
Application No. 12/117,190 is a continuation-in-part of application No. 11/856,917, filed on Sep. 18, 2007.

(51) Int. Cl. G09B 19/00

(52) U.S. Cl. 434/127

(57) ABSTRACT

A system and method for method defining, creating, and managing meals according to user preferences regarding a diet plan, preferred foods, preferred meal preparation options, and meal times. An expert system uses information about an individual's diet preferences and related goals, to develop a personalized plan including a complete meal plan and to generate meal suggestion messages for each meal. Meal suggestion messages are transmitted to users' portable devices at their preferred meal times. If a user accepts a meal suggestion, nutritional information regarding the accepted meal is tracked and considered in determining the user's progress toward a goal. If a user rejects a meal suggestion, the expert system generates a meal substitute suggestion or a specific food item substitute suggestion. When the user accepts the substitute suggestion, nutritional information regarding the substituted meal or food item is tracked and considered in determining the user's progress toward a goal.

### CROSS-REFERENCE TO RELATED APPLICATIONS

This application is a continuation-in-part application of U.S. patent application Ser. No. 12/117,190, filed May 8, 2008, titled METHOD FOR TAILORED STRATEGY MESSAGES FROM AN EXPERT SYSTEM TO ENHANCE SUCCESS WITH MODIFICATIONS TO HEALTH BEHAVIORS, which is incorporated herein by reference and is a continuation-in-part application of U.S. patent application Ser. No. 11/856,917 filed Sep. 8, 2007, titled SYSTEM AND METHOD FOR REWARDING USERS FOR CHANGES IN HEALTH BEHAVIORS, which is incorporated herein by reference.

### TECHNICAL FIELD

The present invention relates generally to systems and methods for assisting with the maintenance of healthy lifestyle habits. More particularly, the present invention is a system and method defining, creating, and managing meals according to user preferences regarding a diet plan, preferred foods, preferred meal preparation options, and meal times.

### BACKGROUND OF THE INVENTION

Dieting has become an extremely popular activity resulting from people's awareness of the health risks of becoming overweight or obese, a desire to improve one's appearance, and an aspiration to achieve the sense of accomplishment that comes from setting a difficult goal and accomplishing it. However, there is no singular method of dieting that works for every person. Body types, weight loss goals, and preferences vary greatly depending on the individual. Every dieter has individual likes and dislikes as to types of food, times and places to eat, type and length of exercise, eating habits, etc. Due to these differences, many dieters become frustrated with rigid, impersonal diets, and often quit the diet after a short time.

Furthermore, dieters differ on how well they can motivate themselves to continue to adhere to certain dietary guidelines. For example, a dieter who is supposed to only eat a cup of pasta and a vegetable for lunch, but instead decides to eat an ice cream cone as well may be unable to justify such a decision within the diet and decide to give up the diet for the rest of the day. Because such “splurges” are detrimental to the dieter's physical and mental progress, the dieter may find the diet unsustainable.

A highly effective solution to these problems is found through the use of coaching. Research has shown that dieting and weight loss is more successful when the dieter is coached throughout the process. Coaching keeps the dieter motivated, provides positive reinforcement, and introduces a narrowly-tailored plan for each individual participant. However, obtaining a reliable human coach is difficult and prohibitively expensive such that relatively few dieters are actually able to use one.

### SUMMARY OF THE INVENTION

The present invention relates generally to systems that promote healthy lifestyles and, in some embodiments, to weight loss systems. The present invention is an improvement upon existing weight loss systems in that it provides an enhanced support system to help dieters follow a personalized diet and exercise plan. The system and method may be used to motivate dieters as well as keep them on a healthy diet while at the same time allowing flexibility in different dieting aspects including, but not limited to, types of food, types of food preparation, amount of food, and amount of exercise.

The system and method address the diet and exercise problems identified above by providing personalized plans to meet the needs and requirements of individuals. It uses tailored messages to “coach” individuals in following their personalized plans. An expert system uses information about an individual's diet and exercise preferences to provide tailored messages related to the plan. The individual receives personalized instruction in the dieting field, without having to pay the prohibitively expensive fees that are typically associated with personalized instruction. Exemplary embodiments allow the individual to use portable devices and technology, such as cell phones, PDA's, Blackberrys™, iPhones™, and others, so that the individual has constant access to personalized instruction regarding his or her personalized diet and exercise plan.

It has been found, through the study of behavior informatics, that the use of technology can help people make significant changes in their health. Gradual change, over a longer period of time, is more effective for long-term health solutions, rather than behavior changes that are expected to take place rapidly, over a short period of time. Further, many dieters are more comfortable using familiar technology to assist them with their dieting, as opposed to unfamiliar and possibly uncomfortable office and training room sessions with an actual dietitian and trainer. These concepts are incorporated into a diet and exercise instructional platform based on individuals' preferences to increase the likelihood that individuals will adopt and follow a plan that helps them reach their personal goals.

The personalized instruction is based on an individual's diet plan preferences, food preferences, meal preparation preferences, and exercise preferences. Once the dieter's plan has been established, typically by providing preference and other information through an online website, the dieter is never required to access the site again as the personalized instruction is given through the dieter's portable technology. The prior art is known to center around “pull” technology, where the user must reach out to the system for the information, and if there is inaction by the user, the instruction will stop. Embodiments utilize “push” technology, where the instruction is sent to the user, and inaction by the user prompts the system to reach out to the user for corrective actions and encouragement.

The system and method focus directly on one of the most problematic hurdles that a dieter must traverse-changing regular meal habits. Many dieters do not succeed with dieting products in the prior art because the meal plans are too rigid, and do not account for the wide variation in tastes and preferences that everyone has when it comes to their food. Furthermore, the prior art provides meal instruction based on ideal circumstances, where the dieter has no preference in what type of food he or she will eat, the dieter has time to purchase foods and prepare meals or the finances to purchase pre-packaged, and the dieter has the instant ability to completely change eating habits (which sometimes have been developed over a period of many years). Meal instruction in the prior art fails to account for the fact that dieters have preferences regarding what they eat and that most dieters do not always have the money to purchase pre-packaged meals or the time to prepare their meals at home. Furthermore, gradual change is much more achievable and effective than rapid change for long term health benefits.

The system and method allow for increased flexibility in meal plans by providing a “smart system” of personalized diet instruction and meal suggestions that can facilitate gradual dietary changes while also allowing the instantaneous substitution or alteration of entire meals or portions of meals, through the use of the portable technology format. Initially, when a dieter begins use of the system, he or she is asked to choose among the various types of diet formats with which many dieters are familiar. For example, existing styles of diets are offered to the user, such as balanced, low carbohydrate, high protein, low fat, ethnic foods, vegetarian, Kosher, low calorie, low sugar, seafood-based, etc., which are pre-determined to limit the meal suggestions to the type of foods that the dieter typically eats or should eat based on his or her goals. Other examples of pre-existing diet plans are South Beach™, Atkins™, and Weight Watchers™. Furthermore, the user is prompted to select various foods that he or she specifically dislikes or prefers. The system may utilize “drag and drop” technology allowing the user to select foods by moving icons across the screen. The user is also prompted to select a level of cooking expertise, so that preparation skills are taken into account when meals are suggested.

The meal system and method is advantageous over the prior art for many reasons. First, allowing the user to begin the program with a meal plan that is similar to an existing diet facilitates the user's transition because it allows the user to begin the program without the feeling of a drastic change. Second, using the portable technology platform also facilitates the user's transition because it is a technology with which the user is already comfortable and it is available anywhere and at anytime. Third, as the user adds or removes selected types of foods within a diet format, he or she can gradually move towards new eating habits rather than trying to change habits rapidly. Fourth, meals that conform to the user's preferences regarding a diet plan, food preferences, and meal preparation options as well as dieting goals are suggested thereby increasing the likelihood that the user will accept the suggestions.

The user has access to a meal plan and meal suggestions from a portable technology device. Meal reminders are sent to the user from the system, reminding him or her of the meal plan, and suggesting possible choices for the upcoming meal. The meal suggestions also contain a details section with instructions and tips to accompany the meal. The meal suggestions may be for meals that can be purchased at a market and prepared by the user, or for local restaurants. The system maintains a large database of food items that are available at markets and groceries, as well as popular restaurants. The database also includes the associated portions and nutritional information for each of the food items. The system also allows the user to enter unique food items that he or she typically eats, along with their nutritional information.

By constantly interacting with the user, the system is capable of dynamic changes, where the meal plan can be instantaneously altered. The user may accept the suggestion of the system, ask for another suggestion, or manually input the meal that he or she would prefer to eat. The user may use a search function, allowing a search for a food by its name, food identifier, company, or brand and may substitute specific foods within a given meal. The user may also increase or decrease portion sizes. Once the user selects a meal, either from the system's suggestions or by manual selection, the system then automatically calculates and records the nutritional information of the meal, and takes note of the user's preference for a certain restaurant or meal within that restaurant. The user can then access the system's web site to see various summaries, charts, and graphical representations of the parameters of the diet plan and progression within it.

The use of location-based services further enhances the system's dynamic change ability. By knowing the exact location of the user at the time just prior to the meal, the system can suggest only restaurants or markets that are in a close proximity to the user at that time. This feature further accommodates the user so that adherence with the system's suggestions presents as little difficulty as possible. Furthermore, if the user slips from the program and does not regularly respond to the messages, the system can still track the user's visits to specific restaurants and note that as a preference of the user when the system provides meal suggestions in the future. Also, the location-based services can also be used to verify the user's response to meal suggestions. For example, if the user accepts a meal suggestion of a restaurant and the user never comes within a five mile radius of the restaurant, the system will prompt the user again for a correction.

The “push” technology is extremely beneficial for dieters in that when there is inaction by the user (i.e., no responses to any meal suggestions or manual entries) the system continues to contact the user, giving him or her words of encouragement to continue the diet. This approach is advantageous over the previous technology where inaction by the user causes the interaction between the user and system to stop, possibly ending the user's diet plan.

The system is beneficial for users who are on a limited budget. Many users frequent certain restaurants or markets due to the lower cost of foods there. With the option of setting restaurant and market preferences, along with being able to refuse the specific suggestions from the system that may be too expensive, the user can remain on the diet plan without having to exceed a budget.

The system is beneficial for users who travel frequently. Remaining on a specific diet and tracking success is especially difficult when the dieter is in an unfamiliar location. Just finding a meal, let alone finding a specific meal that fits within a diet plan, is often difficult. The use of the location-based services solves these problems, especially for those users who have conditions that limit their meal options.

In addition to the novel features and advantages mentioned above, other features and advantages will be readily apparent from the following descriptions of the drawings and exemplary embodiments.

### BRIEF DESCRIPTION OF THE DRAWINGS

FIG. 1 is a screen shot of one embodiment of the meal plan selection user interface.

FIG. 2 is a screen shot of one embodiment of the food filter user interface.

FIG. 3 is a screen shot of one embodiment of the meal preparation user interface.

FIG. 4 is a screen shot of one embodiment of the daily meal summary and food substitution user interface.

FIG. 5 shows an embodiment of the physical structure of the system.

### DETAILED DESCRIPTION

A “smart system” of personalized diet instruction facilitates gradual dietary changes while also being capable of dynamic changes, allowing the instantaneous substitution or alteration of entire meals or portions of meals, through the use of the portable technology format. The system begins by providing a user interface which allows the user to design the most appropriate meal plan based on personal preferences and health goals. An expert system that generates meal suggestions uses the personal preferences and health goals of each user as well as nutritional information regarding various foods and food combinations to determine the content of the meal suggestions. The meal suggestions are then sent to the user's portable device in advance of each meal based on the user's preferred meal times.

Users complete an enrollment process in which they provide user profile data including background and preference data. The user provides contact and background information, specifies a weight or other diet/exercise goal, specifies preferences related to diet and exercise, and identifies personal behavioral challenges. The user's profile data and specified goal and diet and exercise preferences are considered by an expert system to tailor messages intended to reinforce and motivate behaviors that are important in helping the user reach the specified goal. The user accesses a website to navigate through the screens and provide data and information that allows the system to build a profile for the user comprising diet and exercise preferences as well as behavioral challenges.

Initially, a user may be asked to specify a sex, age, weight, and height and a goal weight 200. This information is saved in the user's profile and used to determine the user's progress toward the goal. The expert system generates tailored messages that help the user to progress toward the specified goal.

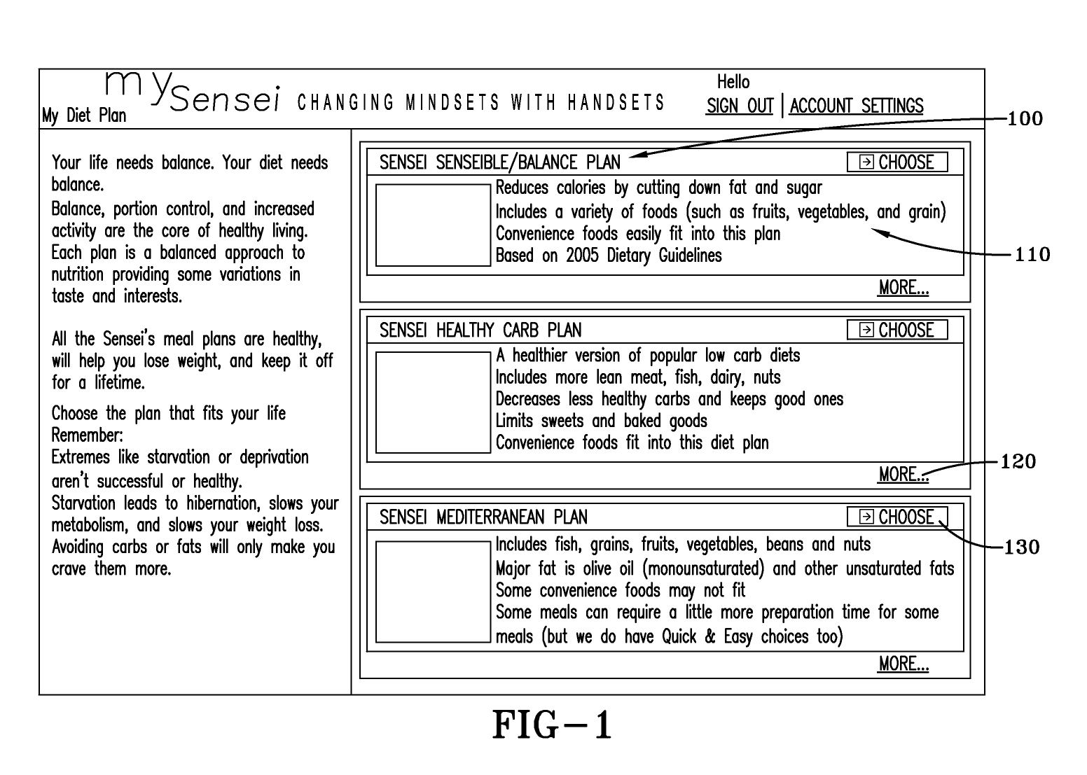

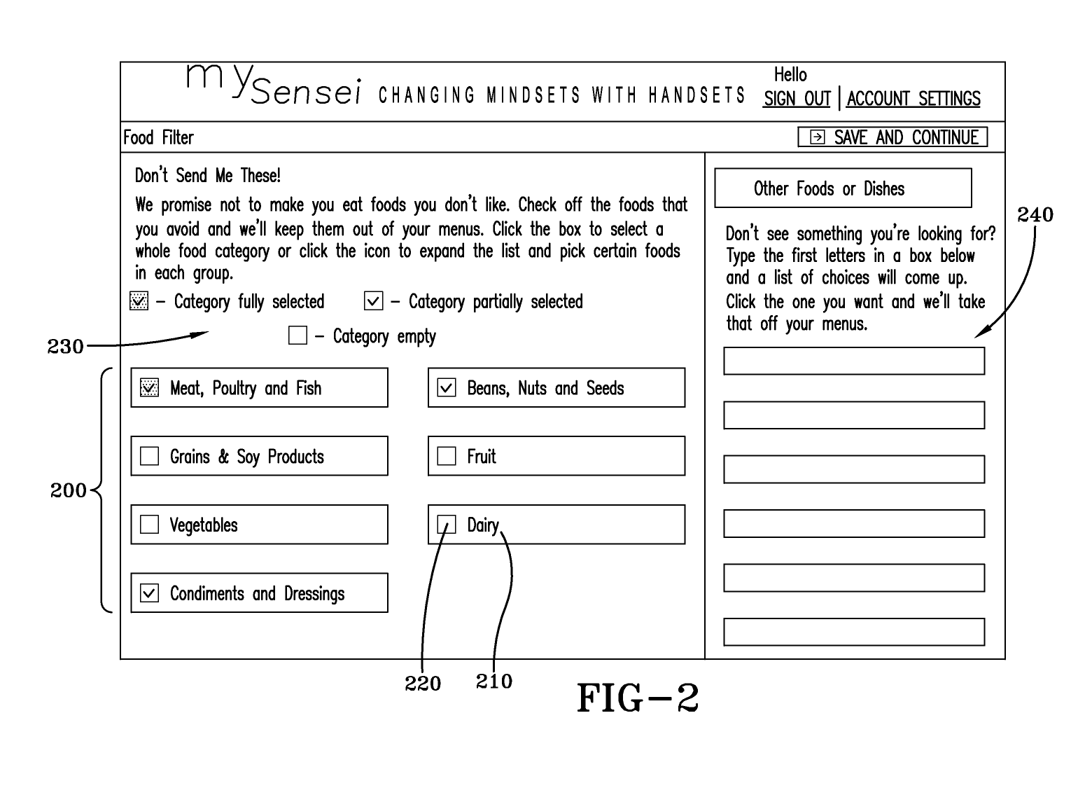

FIG. 1 shows a screen shot of one embodiment of the meal plan selection user interface. Meal plan headings 100 are shown for various popular diet and health plans. A brief description 110 is found just below the title for the specific plan. By selecting the “more” link 120, the user can read more detailed information about the specific plans. The “choose” link 130 allows the user to easily select a preferred meal plan. Meal suggestions provided by the expert system are consistent with the user's selected meal plan.

FIG. 2 shows a screen shot of one embodiment of the food filter user interface. The food filter permits a user to instruct the system on foods that the user does not enjoy or cannot eat. Once a type of food is filtered out, the system does not suggest or include that type of food in the user's meal plan. Section 200 shows the large categories of foods that can be excluded. In an example embodiment, the categories include: 1) meats, poultry, and fish; 2) beans, nuts, and seeds; 3) grains and soy products; 4) fruit; 5) vegetables; 6) dairy; and 7) condiments and dressings. By selecting the individual title of the category 210, the user can expand the category to show all foods which are included within that category. The user can then decide whether to filter out the entire category, or only filter out specific foods within that category. The indicator box 220 shows whether the entire category has been filtered, a portion has been filtered, or the entire category is unfiltered. The key 230 shows the various types of indicator boxes 220 and the meaning of each box. If the user wishes to filter a specific food and that food is not found within any of the categories, the user may type the name of the food into the other food box 240 to search for that specific food and filter it as well.

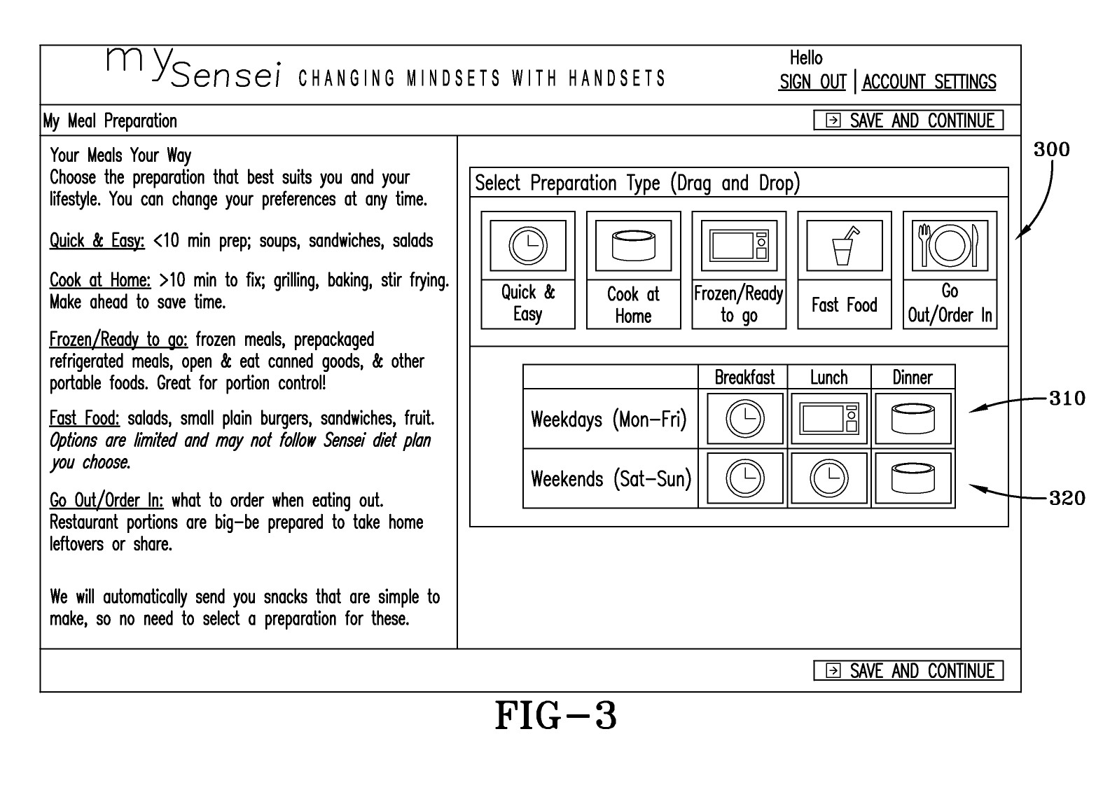

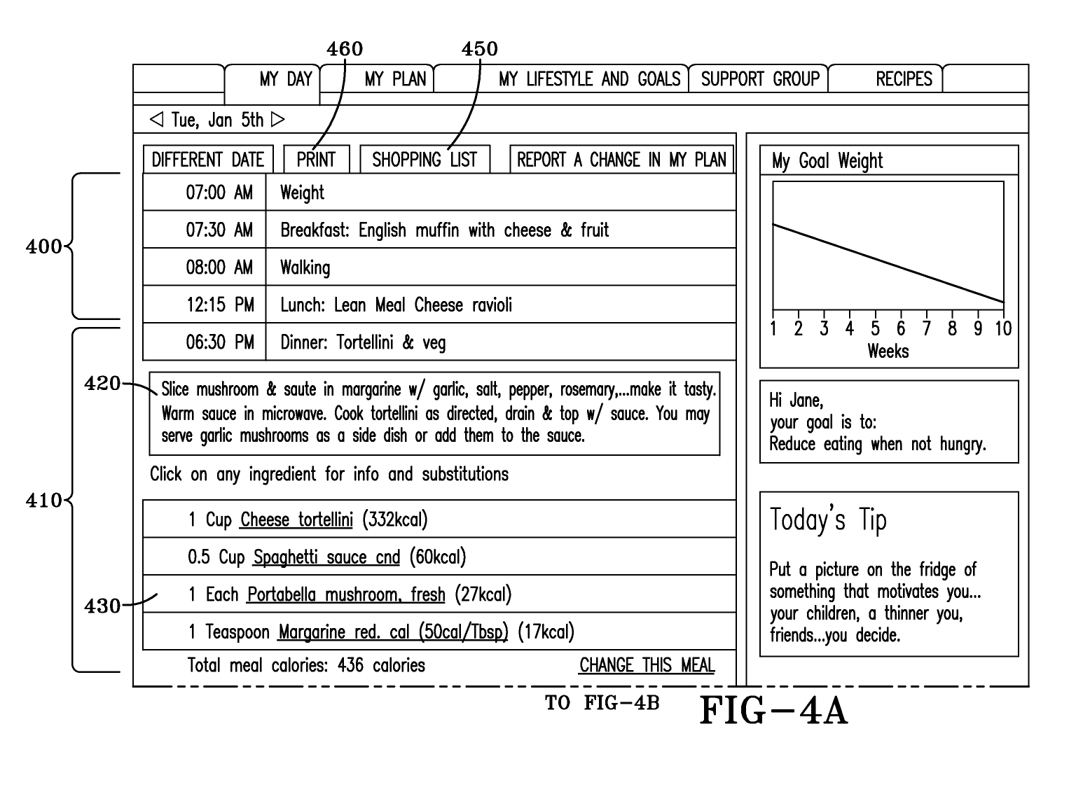

FIG. 3 is a screen shot of one embodiment of the meal preparation user interface. Five different meal preparation types 300 are given as options. In an example embodiment, the meal preparation options are: 1) quick and easy (fewer than 10 minutes to prepare); 2) cook at home (more than 10 minutes to prepare); 3) frozen or ready to eat; 4) fast food; or 5) order from restaurant. The preparation types for breakfast, lunch, and dinner are moved into the weekday 310 or weekend 320 rows using “drag and drop” technology that is well known in the art. Selection of meal preparation types helps the system to understand what type of meals the user would typically eat for each meal of the day throughout the week. This information is used by the system to ensure that the meals being suggested are something that the user would typically eat for that specific meal.

On another screen, the user further specifies a time of day for eating breakfast, lunch, and dinner as well as a snack 214. The user specifies two sets of meal times, one for weekdays and one for weekends. The meal time data as well as the meal preparation preferences and food preferences are used by the expert system in generating meal suggestions.

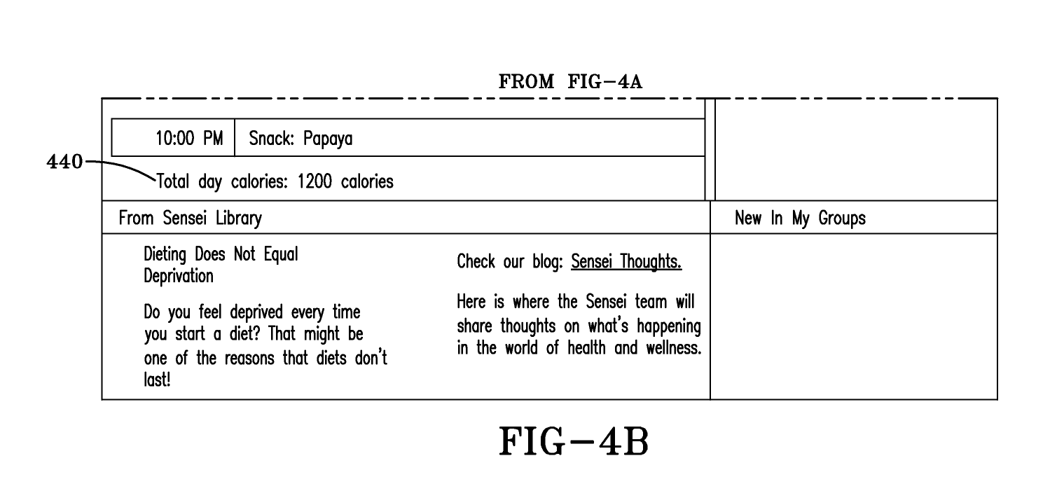

FIG. 4 is a screen shot of one embodiment of the daily meal summary and food substitution user interface. Various events of the day are shown with the time of the event and the event heading 400. An exploded version 410 of the dinner heading is also shown. Details 420 about the preparation of the suggested dinner are given once the dinner heading is exploded. Each ingredient 430 for dinner is also shown in the exploded view, and if the user selects on each ingredient he or she can see additional details about that ingredient, and may remove the ingredient or substitute another ingredient in its place. The total calories for the day 440 is also shown in this embodiment. The user may select a “shopping list” icon 450 that generates a list of all the ingredients for the day that the user should purchase to make suggested meals. The user may select a “print” icon 460 in order to print the meal summary and food substitution page.

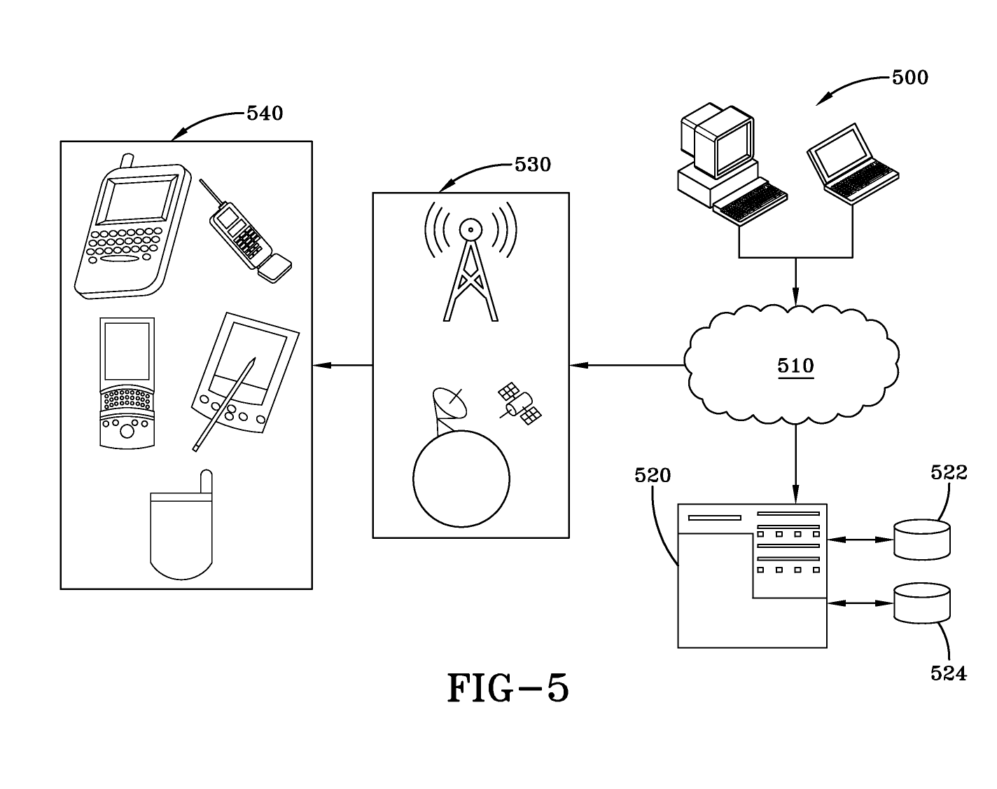

FIG. 5 shows an embodiment of the physical structure of the system. Each of the connections mentioned here permit data to flow in both directions. A laptop or desktop personal computer 500 is connected to the server 520 through the internet 510. The user may connect to a website to create an account and enter personal information and preferences for creating a profile. The server 520 is connected to one or more databases 522, 524 comprising user data, nutrition provider data (nutritional data related to meals offered by a plurality of meal providers), diet, and exercise data, message data, progress data, compliance data, restaurant, shopping, and entertainment establishment data, reward data, and other data as may be required to provide the features and functionality of the present invention. The server 520 is connected to communication networks 530 (comprising various data transmitters and receivers) through the internet 510. The various data transmitters and receivers of the communication networks 530 facilitate communications with the user's portable technology 540 which includes cellular or mobile phones, personal digital assistants, or any other portable device capable of sending and receiving communications through the communication networks 530 and displaying them for a user. An expert system at the server uses the individual's account information, including information about the individual's mobile phone, to tailor and send to the individual messages to reinforce and motivate healthy habits.

In an example embodiment, the expert system is constructed using the J2EE programming language in conjunction with a SQL based database (like Microsoft SQL Server or Oracle DB). AJAX, Active X, and Java components may also be used to handle various aspects of the system. The mobile component of the overall system is constructed using the J2ME programming language sending wireless requests to the expert system over common carrier communication protocols. Communication between the mobile component and the expert system is constructed using XML language structures.

The expert system at the server uses data from the nutrition and recipe database to generate meal suggestions for users according to their food and meal preparation preferences. Nutrition information for individual food items as well as recipes and portion data are maintained in the nutrition and recipe database to facilitate meal suggestions. Unique meal titles and details as well as descriptions for meal options are also maintained to facilitate generation of meal suggestions. Meals can be copied into other calorie levels or plans for adjustment. Foods are easily added to the database and may be searched by name, company, brand, or other identifier.

When generating meal suggestions, the expert system automatically calculates portion sizes along with nutrient values so that meal suggestions are consistent with a user's specified goal or an intermediate goal as determined by the expert system as well as the user's food and meal preparation preferences. The meal suggestions include healthy meal choices from fast food and other types of restaurants based on nutrition and recipe data for food selections from many different restaurants. The meal suggestions also include options for preparing meals or snacks at home or preparing frozen or ready to eat meals.

Meal suggestion messages are sent according to each user's meal time preferences. Messages are sent in advance (e.g., 15 minutes) of each meal or snack. Users accept or reject meal suggestions. If a user rejects a meal suggestion, the expert system suggests substitute meals or even substitute food items within a meal. When a user accepts a meal or substitute meal or food item, the expert system determines the nutritional value of the accepted meal or item and considers it in tracking the user's progress toward a goal. For example, if the nutritional data suggests that a user should be reaching a particular weight goal but the user reports a higher than expected weight, the expert system may solicit additional information from the user to determine why the user is not reaching the goal.

Using a portable technology platform facilitates the incorporation of other technologies such as location-based services (e.g., GPS) to expand the scope of meal suggestions generated under the present invention. Portable technology contains location based technology such as GPS, and allows use of this technology for messaging purposes. For example, knowing the location of the user allows the system to suggest meals from restaurants and markets in the user's current area.

Any embodiment may include any of the optional or preferred features of the other embodiments. The exemplary embodiments herein disclosed are not intended to be exhaustive or to unnecessarily limit the scope of the invention. The exemplary embodiments were chosen and described in order to explain the principles so that others skilled in the art may practice the invention. Having shown and described exemplary embodiments, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

1. A method for managing meals for a user according to personalized meal plans comprising:
a) storing in a nutrition database nutritional data for a plurality of food items and recipe data for creating meal suggestions comprising said food items;
b) receiving from a user profile data comprising:
i. a meal plan preference;
ii. food preferences;
iii. meal preparation preferences;
iv. meal time preferences; and
v. a dietary goal;
c) storing in a user profile database said user data;
d) developing a meal plan for said user comprising food items from said database consistent with said user meal plan preference, food preferences, and meal preparation preferences, said meal plan developed using nutritional data from said nutrition database to determine meals consistent with said user's dietary goal;
e) generating a meal suggestion message comprising a meal suggestion based on said meal plan; and
f) transmitting said meal suggestion message to the user according to said user meal time preferences.

2. The method of claim 1 further comprising:
g) receiving from said user an acceptance response to said meal suggestion message;
h) generating further messages comprising additional meal suggestions for said user based on said meal plan; and
i) receiving further responses from said user regarding said meal suggestions.

3. The method of claim 2 further comprising:
j) receiving from said user a rejection response to said meal suggestion message;
k) accessing said nutrition database to determine a substitute meal for said user according to said user meal plan preference, food preferences, and meal preparation preferences;
l) generating a substitute meal suggestion message comprising said substitute meal; and
m) transmitting said substitute meal suggestion message to said user.

4. The method of claim 2 further comprising:
j) receiving from said user a rejection response to said meal suggestion message;
k) accessing said nutrition database to determine a substitute food item for said user according to said user meal plan preference, food preferences, and meal preparation preferences;
l) generating a substitute food item message for substituting a particular food item in said meal suggestion; and
m) transmitting said substitute food item message to said user.

5. The method of claim 4 further comprising:
n) calculating nutrition information for said meal based on said substitute food item; and
o) storing said nutrition information for said meal for use in determining additional meal suggestions for said user.

6. The method of claim 1 further comprising:
g) providing said user with access to said meal plan; and
h) allowing said user to substitute at least one meal in said meal plan;

7. The method of claim 6 further comprising allowing the user to search said nutritional database for a specific substitute meal.

8. A system for managing meals for a plurality of users according to personalized meal plans comprising:
a nutrition database comprising nutritional data for a plurality of food items and recipe data for creating meal suggestions comprising said food items;
a user profile database comprising user profile data for a plurality of users wherein said user profile data comprises:
a) meal plan preferences;
b) food preferences;
c) meal preparation preferences;
d) meal time preferences; and
e) weight goals;
an expert system for:
a) developing meal plans for each of said users comprising food items from said database consistent with said user meal plan preferences, food preferences, and meal preparation preferences, said meal plans developed using nutritional data from said nutrition database to determine meals consistent with said users' weight goals; and
b) generating meal suggestion messages for each of said users based on said meal plans for each of said users; and
a server for transmitting meal suggestion messages to each of said users wherein said meal suggestion messages are transmitted according to each of said users' meal time preferences to a communications network for delivery to each of said users' portable devices.

9. The system of claim 8 wherein at least one of said users transmits a rejection response to a meal suggestion message, said expert system accesses said nutrition database to determine a substitute meal for said user according to said user's meal plan preferences, food preferences, and meal preparation preferences, and said server transmits a substitute meal suggestion message to said communications network for delivery to said user's portable device.

10. The system of claim 8 wherein at least one of said users transmits a rejection response to a meal suggestion message, said expert system accesses said nutrition database to determine a substitute food item for said user according to said user's meal plan preferences, food preferences, and meal preparation preferences, and said server transmits a substitute food item suggestion message to said communications network for delivery to said user's portable device.

11. The system of claim 8 wherein said meal preparation preferences are selected from the group consisting of: fewer than 10 minutes to prepare; more than 10 minutes to prepare; frozen or ready to eat; fast food; and order from restaurant.

12. The system of claim 8 wherein said expert system generates for at least one user a meal suggestion message comprising a meal available from a restaurant.

13. The system of claim 12 wherein said expert system receives current location information for said at least one user and generates a meal suggestion message comprising a meal available from a restaurant in proximity to said user's current location.

14. The system of claim 8 wherein said expert system generates for at least one user indicating a meal preparation preference for preparing home meals a shopping list according to said user's meal plan preferences and food preferences.
